(19) United States
(12) Patent Application Publication
(10) Pub. No.: US 2011/0301781 A1
(43) Pub. Date: Dec. 8, 2011

(54) METHOD FOR CALIBRATING AN ANGLE SENSOR AND VEHICLE WITH AN ANGLE SENSOR

(75) Inventors: Jan Karlsson, Eskilstuna (SE); Andreas Ekvall, Hallstahammar (SE)

(73) Assignee: VOLVO CONSTRUCTION EQUIPMENT, Eskilstuna (SE)

(21) Appl. No.: 13/131,268

(22) PCT Filed: Nov. 26, 2008
(86) PCT No.: PCT/SE2008/000658

§ 371 Date: Jun. 14, 2011

(51) Int. Cl. G06F 19/00; G06F 7/00

(52) U.S. Cl. 701/1; 702/85

(57) ABSTRACT

A method for calibration of at least one angle sensor sensing an angular position of a pivotable element rotatable from a first position to a maximum position is provided, wherein during an operation time of the pivotable element at least one adjustable angle corresponding to an extreme value of the angle sensor is automatically maintained or updated depending on at least one measured angle determined by the at least one angle sensor.

### BACKGROUND AND SUMMARY

The invention relates to a method for calibrating an angle sensor and a vehicle with an angle sensor.

It is known in the art that for construction equipment, e.g. work machines for moving earth such as digging machines and the like, require more and more angle sensors on various mechanical linkages. Such angle sensors together with the mechanical linkages usually do not provide the tolerances needed during operation and have thus to be calibrated. Calibration however, requires skilled personnel and additional servicing time.

Work machines such as wheel type loaders include work tools which can be moved through a number of positions during a work cycle. Such work tools typically include buckets, forks, and other material handling apparatus. For instance, a typical work cycle associated with a bucket includes sequentially positioning the bucket and associated lift arm in a digging position for filling the bucket with material, e.g. soil or sand, a carrying position, a raised position, and a dumping position for removing material from the bucket.

For instance control levers can be mounted to an actuator, or at the operator's cabin or directly be connected to an electrohydraulic circuit for moving the bucket and/or lift arms. The operator must manually move the control levers to open and close hydraulic valves that direct pressurized fluid to hydraulic cylinders which in turn cause the implement to move. For example, when the lift anus are to be raised, the operator moves the control lever associated with the lift arm hydraulic circuit to a position at which a hydraulic valve causes pressurized fluid to flow to the head end of a lift cylinder, thus causing the lift arms to rise. When the control lever returns to a neutral position, the hydraulic valve closes and pressurized fluid no longer flows to the lift cylinder.

In normal operation, the work tool is often abruptly started or brought to an abrupt stop after performing a desired work cycle function, which results in rapid changes in velocity and acceleration of the bucket and/or lift arm, machine, and operator. This can occur, for example, when the implement is moved to the end of its desired range of motion. The geometric relationship between the linear movement of the tilt or lift cylinders and the corresponding angular movement of the bucket or lift arm can produce operator discomfort as a result of the rapid changes in velocity and acceleration. The forces absorbed by the mechanical linkage assembly and the associated hydraulic circuitry may result in increased maintenance and accelerated failure of the associated parts. Another potential result of the geometric relationship is excessive angular rotation of the lift arm or bucket near some linear cylinder positions which may result in poor performance. Advantageously, angle sensors can be provided for functions like end dampening, automatic positioning, geometric calculations, load calculations etc.

When the work machine is lowering a load and the operator quickly closes the associated hydraulic valve, stresses can also be produced. The inertia of the load and work tool exerts forces on the lift arm assembly and hydraulic system when the associated hydraulic valve is quickly closed and the motion of the lift arms is abruptly stopped. Such stops cause increased wear on the work machine and reduce the operator comfort. In some situations, the rear of the work machine can even be raised off of the ground.

Further, prior methods and apparatus have suffered from inconsistent control of rate of motion and stopping position. This inconsistent control is believed to be a result of controlling solely on velocity or by scaling the operator command signal.

U.S. Pat. No. 6,912,455 B2 discloses a calibration method of a steering arrangement comprising a steering motor having end stops by correlating the steering motor angle and the handwheel angle every time the vehicle starts.

WO 2004022411 A1 describes a power steering device for an electromechanically steered vehicle comprising a. variable software end stop that is increased with increasing steering angle.

It is desirable to provide an improved method for calibrating an angle sensor. It is also desirable to provide a vehicle with an angle sensor which can be easily calibrated.

According to a first aspect of the invention, a method is proposed for calibration of at least one angle sensor sensing an angular position of a pivotable element rotatable from a first position to a maximum position, wherein during an operation time of the pivotable element at least one adjustable angle corresponding to an extreme value of the angle sensor is automatically maintained or updated depending on at least one measured angle determined by the at least one angle sensor.

Advantageously, a manual calibration of the at least one angle sensor can be avoided, as the method provides a self adapting calibration. The updated adjustable angle is preferably stored in a memory coupled to the at least one angle sensor, particularly in a control device controlling the angle sensor. The invention can be advantageously employed for all types of mobile applications where positioning is required, for instance for an articulated work machine. Favourably, a “soft stop” function of such an articulated work machine can easily be adjusted by taking account of the updated adjustable angle. In a “soft stop” function the rotational movement of the articulated element, e.g. a work tool pivotably attached to the work machine, is damped just before the mechanical stop (end position) of the angular movement is reached. The soft stop reduces the wear of the work tool, the joints, the bearing etc. If during the lifetime of the work machine the wear of the machine induces an increase of the measured angle, the calibration method allows for tracking the increase simultaneously. Thus, the angle sensor can be adaptively calibrated by updating the adjustable angles according to the measured angle when the end positions (mechanical stop) of e.g. hydraulic pistons change over time by wear.

A manual calibration or manually initiated calibration is not necessary as the method can automatically calibrate the at least one angle sensor during the whole lifetime of a device, e.g. a vehicle such as a work machine, where the at least one angle sensor is coupled to.

Preferably, the maximum position of the pivotable element is represented by the extreme value of the angle sensor. Favourably, by sensing the available operating range of the pivotable element over the operating time the pivotable element is protected against abrupt termination of an angular movement at a mechanical stop.

According to a favourable embodiment, the adjustable angle can be chosen to be equal or larger than an initial angle, wherein initially at the beginning of the overall operational time of the pivotable element the initial angle is set as extreme value for the angle sensor corresponding to the initial maximum position of the pivotable element. Preferably, the initial angle equals a nominal angle representing a nominal mechanical stop minus tolerances such as one or more tolerance values of at least one of tolerance in a mechanical linkage providing the rotatable movement, and/or a mechanical installation tolerance of the angle sensor and/or an electrical measurement tolerance of the angle sensor. The nominal mechanical stop can be a design value representing an estimate of the mechanical stop. Preferably, the adjustable angle can be an angle value corresponding to an angle defined by a current mechanical stop of the pivotable element.

According to a further favourable embodiment, a plausibility check can be performed regarding the measured angle before the adjustable angle is maintained or updated. This allows for eliminating sensor faults which may tamper the measurement.

According to a further favourable embodiment, the adjustable angle can be updated with a value not exceeding a maximum angle if the measured angle is greater than the maximum angle. Preferably, the maximum angle equals the nominal angle corresponding to the nominal mechanical stop plus one or more tolerance values of at least one of tolerance in a mechanical linkage providing the rotatable movement, and/or a mechanical installation tolerance of the angle sensor and/or an electrical measurement tolerance of the angle sensor. By providing a maximum angle it can be avoided to increase the adjustable angle indefinitely, and a reasonable abort criterion can be provided. By including one or more tolerances, a reasonable estimate of a maximum possible increase of the end position can be provided.

Favourably, at least a tolerance in the mechanical linkage providing the rotatable movement of the pivotable element and/or a mechanical installation tolerance of the angle sensor and/or an electrical measurement tolerance of the angle sensor can be included. Electrical measurement tolerances include for example cable harness, sensor tolerances, connectors, A/D converter etc. Such one or more tolerances can be expressed as angle values and can add up to a reasonable maximum correction value. By keeping the adjustable angle below this maximum angle a mechanical damage by rotating or swivelling the element, e.g. a work tool or a steering etc., to a too large angle can be avoided.

According to a further favourable embodiment, the current adjustable angle can be set to a default value if the measured angle is less than the actual adjustable angle and/or if the angle sensor is replaced. Favourably, the current adjustable angle can be reset to the first maximum angle if the measured angle is less than the initial angle and/or if the angle sensor is replaced. The reset can preferably performed by operator or service input. This step can advantageously account for e.g. ageing of the angle sensor which can yield too small measured angle values. A reset is also advantageous if the angle sensor is replaced by a new one.

According to a further favourable embodiment, the adjustable angle can be set equal to the measured angle. Thus, the current mechanical stop is updated in the angle sensor according to the wear of the elements.

According to a further favourable embodiment, at least the initial angle of a first pivotable element can be varied dependent on a basis angle of a mechanically connected pivotable element.

By way of example, the tilt angle of a bucket connected to a boom is dependent on a lift angle of the boom. Preferably, a lookup table can be provided comprising initial angles for one or more linked angles of the mechanically connected pivotable element depending on the basis angle of the mechanically connected pivotable element. For instance, a basis angle, e.g. the tilt angle of a bucket connected to a boom depends on a linked angle, e.g. a lift angle of the boom. This favourably addresses mechanical dependencies in a device, e.g. in a lifting framework of a work machine, where the mechanical stop for the tilt function is dependent on the actual angle of the boom. In such a case, the lookup table values can be adapted to a change in the measured angle value. Favourably, the one or more linked angles can be updated to a value not greater than a stop angle if the measured angle of the linked angle is greater than the stop angle. Instead of using a lookup table it is also possible to calculate the respective angle by a formula expression such as a polynom or the like.

According to another aspect of the invention, a vehicle is proposed comprising at least one angle sensor which is calibrated according to anyone of the method steps described above. Preferably, the vehicle can provide a soft stop function which is performed with an automatically updated angle sensor.

A computer program is proposed comprising a computer program code adapted to perform a method or for use in a method according to anyone of the method steps described above when said program is run on a programmable microcomputer. Preferably, the computer program can be adapted to be downloaded to a control unit or one of its components when run on a computer which is connected to the internet.

A computer program product is proposed stored on a computer readable medium, comprising a program code for use in a method according to anyone of the method steps described above on a computer.

The invention can be applied to wheel-borne vehicles, track-borne vehicles and vehicles running on rails or stationary work machines. The invention is particularly useful for mobile work machines, such as articulated haulers, wheel loaders, excavators etc. The invention can also be applied to passenger cars, trucks, buses and other road vehicles but is primarily favourable for use in applications suffering from high mechanical wear and poor tolerances, which is particularly the case in heavy duty machines such as construction equipment and the like.

### BRIEF DESCRIPTION OF THE DRAWINGS

The present invention together with the above-mentioned and other objects and advantages may best be understood from the following detailed description of the embodiments, but not restricted to the embodiments, wherein is shown:

FIG. 1 an illustration of angles considered in a method according to the invention;

FIG. 2 a flow chart illustrating preferred steps of the method according to the invention; and

FIG. 3 a schematic sketch of a wheel loader indicating mechanical dependencies of an adjustable angle corresponding to an extreme value of the angle sensor (tilt angle of a bucket) on a first angle (lift angle of a boom) of a mechanically connected element (boom).

### DETAILED DESCRIPTION

In the drawings, equal or similar elements are referred to by equal reference numerals. The drawings are merely schematic representations, not intended to portray specific parameters of the invention. Moreover, the drawings are intended to depict only typical embodiments of the invention and therefore should not be considered as limiting the scope of the invention.

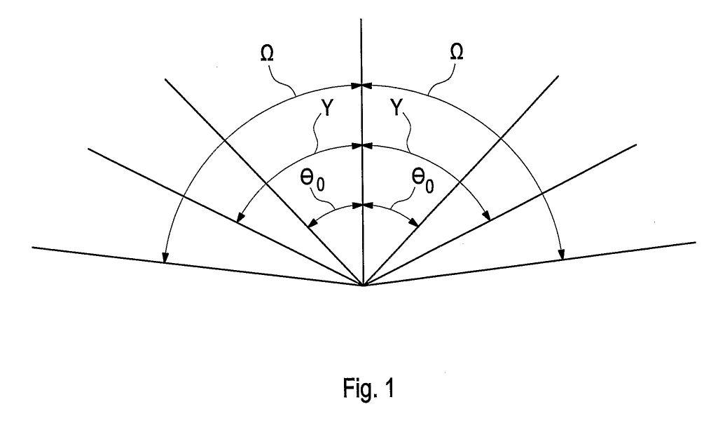

FIG. 1 shows an illustration of an initial angle θ0, an adjustable angle y, i.e. an angle corresponding to an extreme value of an angle sensor, and a maximum angle ω considered in a method according to the invention. By way of example, an articulated work machine (not shown) has one or more physical limitations, i.e. a mechanical stop, referred to by the adjustable angle Y which is corresponding to an extreme value of the angle sensor. The mechanical stop, i.e. the adjustable angle Y can change, particularly increase, over time due to e.g. wear.

In an early stage of the lifetime of the work machine, e.g. after production of the work machine and/or of an pivotably mounted part which replaces a worn pivotably mounted part of the work machine, a control system controlling the articulated movement, e.g. tilting of the pivotably part, by help of one or more angle sensors (not shown) preferably assumes that the extreme values for an angle sensor is an initial angle θo. The one or more angle sensors can preferably be arranged close to the pivot joint of the pivotable part.

The initial angle θ0 is equal or less than a mechanical stop, i.e. an end position, for the work machine, particularly for the pivotable element of the work machine. The initial angle θo preferably includes tolerances in the mechanical linkage providing the rotatable movement, and/or a mechanical installation tolerance of the angle sensor and/or an electrical measurement tolerance of the angle sensor. The initial angle θo is selected so that it is always within the mechanical stop, which corresponds to the second angle y which can increase over time. Preferably, the adjustable angle Y increases from the initial angle θo at the beginning, which represents the minimum value for γ; to the maximum angle ω, which represents the maximum value for the adjustable angle y.

During lifetime of the work machine, the one or more angle sensors will detect measured angles θm of the pivotable element which become larger and larger with time and become greater than the initial angle θo.

According to the invention, the adjustable angle Y for the angle sensor will be automatically updated and thus increase with time.

For a function like a “soft stop” this results in activating the soft stop a little bit too early when the work machine is new. Particularly, the soft stop function can be activated a little bit too early for a new work machine or a replaced part which is subject to the soft stop function.

During use of the work machine, this initial angle θ0 can be exceeded with the mechanical linkage. Consequently, the soft stop function will after some time of usage be activated at the right angle and at the right time. For a safe operation within machine usage time, a limit value of the maximum angle ω can be set which prevents the second angle Y from increasing indefinitely. For instance, if an angle greater than ω is detected the adjustable angle Y will not be updated to a value greater than ωo. The maximum angle ω is preferably equal to a nominal angle representing a nominal mechanical stop plus a tolerance in the mechanical linkage providing the rotatable movement, and/or a mechanical installation tolerance of the angle sensor and/or an electrical measurement tolerance of the angle sensor. The adjustable angle Y varies between the initial angle θo as minimum value and the maximum angle ω as maximum value.

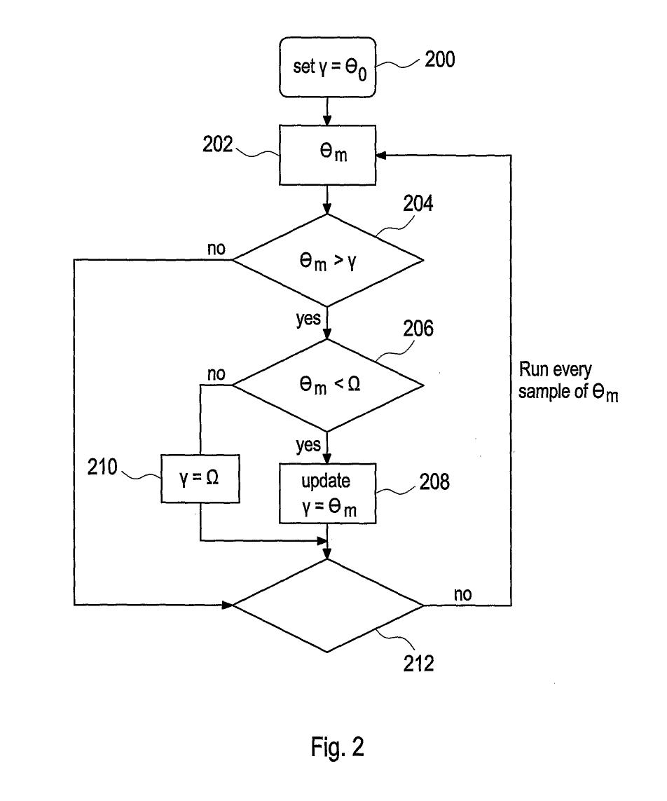

A flow chart is depicted in FIG. 2 summarizing preferred steps of a preferred embodiment of the invention. In step 200, an initial angle y, which is corresponding to an extreme value of an angle sensor, is set to equal an initial angle θ0 for an angle sensor dedicated to a pivotable element with, γ=θo, with y corresponding to a mechanical stop which can vary, particularly increase, with time. The initial angle θo preferably includes tolerances for e.g. the mechanical linkage providing the rotatable movement and/or a mechanical installation of the angle sensor and/or an electrical measurement of the angle sensor and the like. The pivotable element must not be moved to a larger angle than the adjustable angle Y. The initial angle θ0 is an initial value for the mechanical stop in an early stage of the lifetime of e.g. an articulated work machine such as a construction equipment or the like. By way of example, the initial angle θo is equal or below the second angle y.

In step 202, during operation of the pivotable element, the angle sensor detects a measured angle θm as extreme value for the rotation of the pivotable element. In step 204 the measured angle θm is compared to the adjustable angle y. If the measured angle θm is not larger than the adjustable angle y (“no” in the flow chart), an update of the adjustable angle y is either not necessary or a fault is present which may make necessary a reset of the adjustable angle y to a start default value, particularly θo. Thus, the procedure jumps to the step 212. In step 212 it is checked whether a measured angle θm has been compared to the adjustable angle y. Preferably this comparison is done continuously for every new measured angle during operation of the machine and the process can restart with step 200.

If the comparison in step 204 yields that the measured angle θm is larger than the adjustable angle Y (“yes” in the flow chart), then in step 206 the measured angle θm is compared to a maximum angle ω. If the measured angle θm is not less than the maximum angle ω in step 206 (“no” in the flow chart), the adjustable angle y is updated and set to higher value, particularly to γ=ω, which does not exceed the maximum angle ω in step 210. If the comparison in step 206 yields that the measured angle θm is equal or smaller than the maximum angle ω (“yes” in the flow chart), the adjustable angle Y is updated in step 208 and preferably set to the value of the measured maximum angle θm, with γ=θm. Thus, the procedure jumps to the step 212. In step 212 it is checked whether a measured angle θm has been compared to the adjustable angle y. Preferably this comparison is done continuously for every new measured angle during operation of the machine and the process can restart with step 200.

The adaptation of the adjustable angle Y to increasing values of the end position of the pivotable element can be monitored continuously during operation of the element. Alternatively, monitoring can be performed periodically and/or depending on how the pivotable element is used.

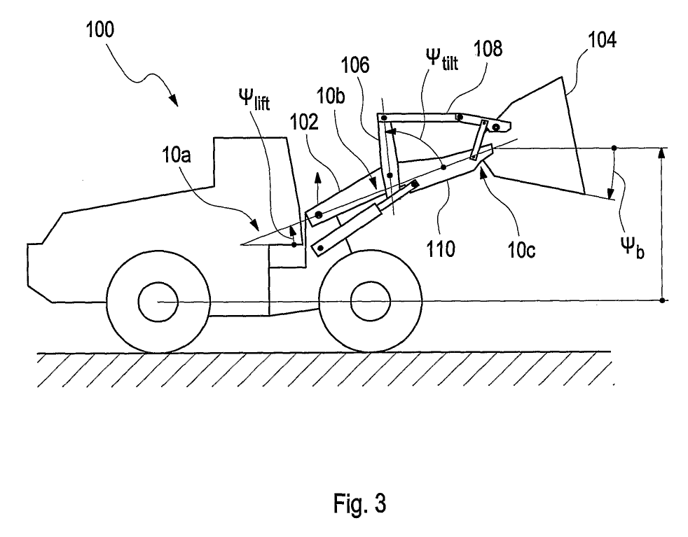

According to a preferred development of the method mechanical dependencies can also be considered. This is illustrated in FIG. 3.

Mechanical dependencies can occur, for instance, in a lifting framework of a wheel loader 100 where the mechanical stop for the tilt angle ψtilt of a bucket 104, is dependent on a lift angle ψlift of a boom 102 on which the bucket 104 is arranged in an articulated manner via struts 106, 108. The lift angle ψlift is a basis angle to which the tilt angle ψtilt is linked. A variation of the basis angle alters the linked angle. Thus, the initial angle θ0 is different for each value of the basis angle, i.e. the lift angle ψlift.

When the bucket 104 is tilted with an angle ψtilt, the lower end of the bucket is tilted by an angle ψb with respect to the horizontal direction defined by the centers of the wheels of the wheel loader (indicated by a line through the wheel enters in the drawing). The tilt angle ψtilt of the bucket 104 is the angle between the boom axis 110 and the first strut 106. The angle ψb of the lower side of the bucket 104 is changed by varying the tilt angle ψtilt of the bucket 104. The tilt angle ψtilt of the bucket 104 varies for varying lift angles ψlift of the boom 102. Angle sensors 10a, 10b, 10c are located at positions along the boom 102, preferably pivot joints of the boom 102, the first strut 106 at the boom 102 and the bucket 104 at the boom 102, to detect angular movements of the boom 102, the first strut 106 and the bucket 104.

The initial angle θ0 is now provided in a default lookup table comprising different values for the initial angle θo for the tilt angle ψtilt (linked angle) depending on the basis angle, i.e. the boom lift angle ψlift. This default lookup table is updated when the angle G0 is exceeded for each lift angle ψlift. The angle ψlift corresponds to the adjustable angle y in the flow chart in FIG. 2.

Like in the example described in FIG. 1 an absolute limitation of the linked angle ψlift can be used, for instance by providing a maximum angle ψtilt. The default lookup table may contain any appropriate number of positions of lift angles ψlift. A skilled person may also apply any appropriate interpolation between these angles ψlift.

Preferably, the calibration method provides updating the first maximum angle θo to a greater value than the preceding value. During lifetime of the pivotable element and/or the work machine to which the pivotable element is attached, the initial angle θ0 shows generally an increasing value.

Under certain circumstances, the adjustable angle y may be reset to an initial value of the initial angle θo and can then increase in value over time again. To be able to correct the method for angle sensors which may electrically change over time thus sending out a smaller value than the precedent values or due to a mechanical influence, a reset of the current adjustable angle y to a default initial angle θ0 can be performed. The default initial angle θ0 is preferably the minimum of the adjustable angle Y and is preferably equal to the value after production of the work machine and/or the pivotable element, whichever value may apply.

The reset can be done with an appropriate Human Machine Interface (HMI), for example in a menu on a display with one or more control buttons to press for initiating the reset. The work machine, particularly a controller, can then again update .extreme values of the initial angle θo over time. The same reset procedure can be advantageously applied if an angle sensor is replaced by a new one, or the pivotable element or the mechanical linkage is replaced.

Favourably, the invention can be embodied as hardware, as software or in combination as both hardware and software. In a preferred embodiment, the invention is implemented in software, which includes but is not limited to firmware, resident software, microcode, etc. The software can be coupled to a control system for the one or more angle sensors.

The method according to the invention can also be comprised in a computer program product accessible from a computer-usable or computer-readable medium, such as e.g. an electronic, magnetic, optical, electromagnetic medium, providing a program code for use by or in connection with a computer or any instruction execution system.

Preferably, the computer program comprising a computer program code is adapted to perform the said method or for use in said method when said program is run on a programmable microcomputer. Preferably, the computer program can be adapted to be downloaded to a control unit or one of its components when run on a computer which is connected to the internet.

Favourably, a computer program product can be stored on a computer readable medium, comprising a program code for use in the described method on a computer.

The invention is favourably applicable particularly to all types of construction equipment and similar applications, for example steering, lift framework, suspension, load carrying structure etc. which employ one or more angle sensors for detecting an angular movement of a work tool or the like.

1. A method for calibration of at least one angle sensor sensing an angular position of a pivotable element rotatable from a first position to a maximum position, wherein during an operation time of the pivotable element at least one adjustable angle corresponding to an extreme value of the angle sensor is automatically maintained or updated depending on at least one measured angle determined by the at least one angle sensor.

2. The method according to claim 1, wherein the maximum position of the pivotable element corresponds to the extreme value of the angle sensor.

3. The method according to claim 1, wherein the adjustable angle is chosen to be equal or larger than an initial angle, wherein initially at the beginning of the overall operational time of the pivotable element the initial angle is set as extreme value for the angle sensor corresponding to the initial maximum position of the pivotable element.

4. The method according to claim 1, wherein the adjustable angle is an angle value corresponding to an angle defined by a current mechanical stop of the pivotable element.

5. The method according to claim 1, wherein a plausibility check is performed regarding the measured angle before the adjustable angle is maintained or updated.

6. The method according to claim 5, wherein the adjustable angle is changed to a value not exceeding a maximum angle if the measured angle is greater than the maximum angle.

7. The method according to claim 6, wherein the maximum angle equals a nominal angle plus one or more tolerance values of at least one of tolerance in a mechanical linkage providing the rotatable movement, and/or a mechanical installation tolerance of the angle sensor and/or an electrical measurement tolerance of the angle sensor.

8. The method according to claim 1, wherein the current adjustable angle is set to a default value if the measured angle is less than the actual initial angle and/or if the angle sensor is changed.

9. The method according to claim 8, wherein the current adjustable angle is reset to the initial angle if the measured angle is less than the initial angle and/or if the angle sensor is changed.

10. The method according to claim 1, wherein the adjustable angle is set equal to the measured angle.

11. The method according to claim 1, wherein at least the initial angle of a first pivotable element is varied dependent on a basis angle of a mechanically connected pivotable element.

12. The method according to claim 11, wherein a lookup table is presented comprising initial angles for one or more linked angles of the mechanically connected pivotable element depending on the basis angle of the mechanically connected pivotable element.

13. The method according to claim 1, wherein the one or more linked angles are updated to a value not greater than a stop angle if the measured angle of the linked angle is greater than the stop angle.

14. A vehicle comprising at least one angle sensor which is calibrated according to the method set forth in claim 1.

15. The vehicle according to claim 14, wherein a soft stop function is provided based on sensor data of the angle sensor.

16. A computer programmed with computer program code adapted to perform a method or for use in a method according to claim 1.

17. The computer according to claim 16 adapted to download the computer program code when connected to the internet.

18. A computer program product stored on a non-transitory computer readable medium, comprising a program code for use in a method according to claim 1.

19. A method for calibration of at least one angle sensor sensing an angular position of a pivotable element rotatable from a first position to a maximum position, wherein during an operation time of the pivotable element at least one adjustable angle corresponding to an extreme value of the angle sensor is automatically maintained or updated depending on at least one measured angle determined by the at least one angle sensor.

20. The method according to claim 19, wherein the maximum position of the pivotable element corresponds to the extreme value of the angle sensor.

21. The method according to claim 19, wherein the adjustable angle is chosen to be equal or larger than an initial angle, wherein initially at the beginning of the overall operational time of the pivotable element the initial angle is set as extreme value for the angle sensor corresponding to the initial maximum position of the pivotable element.

22. The method according to claim 19, wherein the adjustable angle is an angle value corresponding to an angle defined by a current mechanical stop of the pivotable element.

23. The method according to claim 19, wherein a plausibility check is performed regarding the measured angle before the adjustable angle is maintained or updated.

24. The method according to claim 23, wherein the adjustable angle is changed to a value not exceeding a maximum angle if the measured angle is greater than the maximum angle.

25. The method according to claim 24, wherein the maximum angle equals a nominal angle plus one or more tolerance values of at least one of tolerance in a mechanical linkage providing the rotatable movement, and/or a mechanical installation tolerance of the angle sensor and/or an electrical measurement tolerance of the angle sensor.

26. The method according to claim 19, wherein the current adjustable angle is set to a default value if the measured angle is less than the actual initial angle and/or if the angle sensor is changed.

27. The method according to claim 26, wherein the current adjustable angle is reset to the initial angle if the measured angle is less than the initial angle and/or if the angle sensor is changed.

28. The method according to claim 19, wherein the adjustable angle is set equal to the measured angle.

29. The method according to claim 19, wherein at least the initial angle of a first pivotable element is varied dependent on a basis angle of a mechanically connected pivotable element.

30. The method according to claim 29, wherein a lookup table is presented comprising initial angles for one or more linked angles of the mechanically connected pivotable element depending on the basis angle of the mechanically connected pivotable element.

31. The method according to claim 19, wherein the one or more linked angles are updated to a value not greater than a stop angle if the measured angle of the linked angle is greater than the stop angle.

32. A vehicle comprising at least one angle sensor which is calibrated according to the method set forth in claim 19.

33. The vehicle according to claim 32, wherein a soft stop function is provided based on sensor data of the angle sensor.

34. A computer programmed with computer program code adapted to perform a method or for use in a method according to claim 19.

35. The computer according to claim 34 adapted to download the computer program code to a control unit or one of its components when run on a computer which is connected to the internet.

36. A computer program product stored on a non-transitory computer readable medium, comprising a program code for use in a method according to claim 19.
